(19) United States
(12) Patent Application Publication
(10) Pub. No.: US 2007/0192822 A1
(43) Pub. Date: Aug. 16, 2007

(54) System and method of failure recovery for a television tuning device

(75) Inventor: Scott White, Austin, TX (US)

Correspondence Address: SCHWEGMAN, LUNDBERG, WOESSNER & KLUTH, P.A., P.O. BOX 2938, MINNEAPOLIS, MN, 55402, US

(73) Assignee: SBC Knowledge Ventures, L.P.

(21) Appl. No.: 11/353,507

(22) Filed: Feb. 13, 2006

(51) Int. Cl. H04N 5/91; H04N 5/50

(52) U.S. Cl. 725/152; 386/83; 348/731

(57) ABSTRACT

A system and method of failure recovery for a television tuning device such as a set-top box is disclosed. The method includes storing, in a memory, channel data identifying a channel to which the set-top box is tuned and after the occurrence of an event, accessing the memory to retrieve the channel data and tuning the set-top box to the channel identified by the channel data. The event may be an interruption of power to the tuning device or a failure of the tuning device.

### FIELD OF THE DISCLOSURE

The present disclosure relates to a tuning device, such as a set-top box.

### BACKGROUND

For years, televisions have been a staple of consumer electronics sales. As such, a large majority of households in the United States owns at least one television. Providing content to those televisions is a lucrative business and there are numerous types of television content to choose from. For example, viewers can subscribe to digital broadband television networks and digital satellite television networks in order to receive standard digital television content or high definition television content.

Viewers use tuning devices, for example set-top boxes, to access the broadcast content.

In the event of a temporary power outage or system crash resulting in a system restart, after the set-top box has completed its reboot, the set-top box tunes to a default channel instead of the channel which was tuned to most recently.

This is obviously not user friendly for a viewer who now needs to tune the set-top box back to the channel they were viewing before the temporary power outage.

### BRIEF DESCRIPTION OF THE DRAWINGS

FIG. 1 is a block diagram representative of an entertainment system including a tuning device; and

FIG. 2 is a flow chart to illustrate general operating logic that can be used to manage a failure recovery of a set-top box.

### DETAILED DESCRIPTION

A method of managing failure recovery of a tuning device is disclosed and includes storing, in a memory of a tuning device, channel data identifying a channel to which the tuning device is tuned. After the occurrence of an event, the memory is accessed to retrieve the channel data and the tuning device is tuned to the channel identified by the channel data.

A system is also disclosed including a memory and a channel storing module to access the memory and to write channel data to the memory, the channel data identifying a channel to which a tuning device is tuned. The system also includes a recovery module which, after the occurrence of an event, accesses the channel data stored in the memory and tunes the tuning device to the channel identified by the channel data.

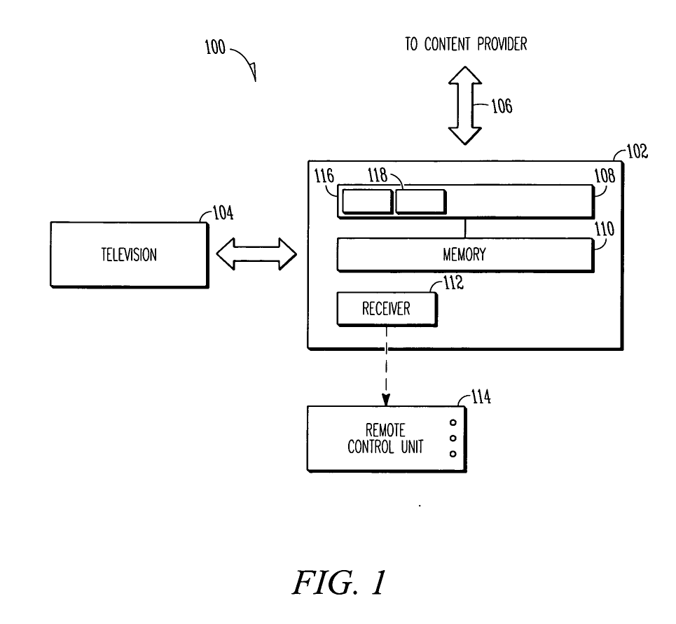

Referring to FIG. 1, a system is shown and is generally designated 100. As shown, the system 100 includes a tuning device in the form of a set-top box 102 that is coupled to a display device, such as a television 104. Additionally, the set-top box 102 is coupled to a content provider 106.

The term set-top box is used generically in this application to mean, but not limited to, Satellite/Cable Tuner, Digital Video Recorder (DVR), Personal Video Recorder (PVR) and other types of devices including a tuner.

It will however be appreciated that although the managing of failure recovery as described herein has been described in the context of tuning device which is a set-top box, the method may find application in other deployment environments using other types of tuning devices, including a television set that includes a tuner.

A set-top box may connect to a television (or other display device) and some external source of signal, and turn the signal into content then displayed on the display device. The signal source might be an Ethernet cable, a satellite dish, a coaxial cable, a telephone line (including DSL connections), or a VHF or UHF antenna. Displayed content may include, for example, video, audio, Internet webpages, interactive games, or other possibilities.

It should be noted that a set-top box may not necessarily contain a tuner of its own. A set-top box connected to a SCART (from Syndicat des Constructeurs d'Appareils Radiorécepteurs et Téléviseurs) connector of a television is fed with the baseband television signal from the television set's tuner, and can request the television set to display the returned processed signal instead. This feature may used for decoding analog Pay TV in Europe, and in the past was used for decoding teletext, before decoders became built-in. The outgoing signal can be of the same nature as the incoming signal, or RGB component video, or even an “insert” over the original signal.

Digital set-top boxes may be used to receive digital terrestrial television through services (e.g., Freeview, a service operated by the Freeview Consortium) or through digital satellite or digital cable.

A set-top box may be used to receive analog cable TV channels and convert them to channels that may be seen on a regular television.

A set-top box may be digital set-top box to receive digital TV broadcasts. In the case of direct broadcast satellite (mini-dish) systems, the set-top box may be an integrated receiver/decoder (IRD).

In IPTV networks, the set-top box may operate as small computer providing two-way communications on an IP network, and decoding the video streaming media.

As shown in FIG. 1, the example set-top box 102 includes a processor 108 and a memory 110 that is coupled to the processor 108. The memory 110 in one embodiment is a non-volatile memory which retains its contents with or without power. Examples of non-volatile memory may include, for example, read-only memory, flash memory, magnetic computer storage devices (e.g., hard disks, floppy disk drives, and magnetic tape), optical disc drives, and early computer storage methods such as paper tape and punch cards. More specifically, examples of non-volatile memory may include a mask-programmed ROMs, programmable ROMs, erasable PROMs, UV-erase EPROMs, OTP (one-time programmable) ROMs, Electrically Erasable PROMs (EEPROMs), flash memory and battery-backed static RAMs

Further, a receiver 112 is coupled to the processor 108. A remote control unit 114 can communicate with the set-top box 102 via the receiver 112. In a particular embodiment, the receiver 112 can be an infrared (IR) receiver or a radio frequency (RF) receiver. A user can input one or more commands to the set-top box 102 using the remote control unit 114.

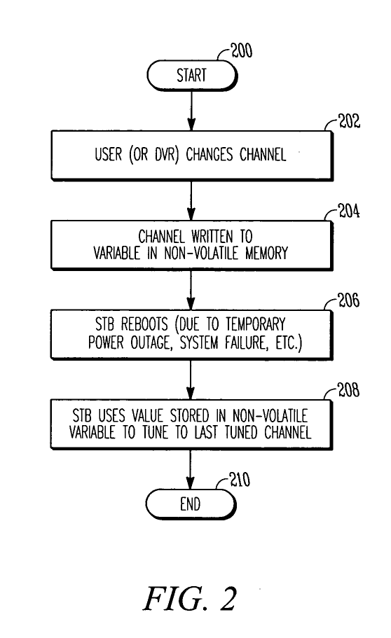

Referring to FIG. 2, one embodiment of a method of managing failure recovery of a tuning device (or tuner) is shown. At block 200, the process is started, and each time the channel that a tuner (e.g., as incorporated within a set-top box 102) is tuned to changes, block 202, channel data is stored in the memory 110 identifying the channel to which the tuner is tuned, block 204.

In one example, the channel may be changed by a user or may be changed by a digital video recorder (DVR) event.

Each time channel data is stored in the memory, previous channel data stored in the memory may be deleted, for example, thus reducing the required memory size. The previous channel data may, for example, be overwritten by new channel data.

At block 206, after the occurrence of an event (e.g., an interruption of power to the set-top box), the set-top box reboots and accesses the memory, block 208, to retrieve the channel data stored therein and to tune the tuner to the channel identified by the channel data.

The process is then ended in block 210.

It will be appreciated that the user is afforded a return to the channel they were watching before the restart. Also, in one embodiment, where the tuner is part of a DVR, the DVR is able to resume a recording which was in progress before the restart.

In one example, the method is implemented in the system illustrated in FIG. 1. In an embodiment the processor 108 includes a channel storing module 116 to access the memory 110 and write channel data to the memory.

The processor also includes in this embodiment a recovery module 118 which, after the occurrence of an event, accesses the channel data stored in the memory 110 and tunes the tuner of the set-top box 102 to the channel identified by the channel data.

It will be appreciated that the various modules described above may be implemented in separate processors.

It will also be appreciated that the various modules described above in one embodiment are implemented using software instructions stored on a machine-readable medium that, when executed by a machine, cause the machine to perform the methods described herein.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method including:
storing, in a memory of a tuning device, channel data identifying a channel to which the tuning device is tuned; and
after the occurrence of an event, accessing the memory to retrieve the channel data and tuning the tuning device to the channel identified by the channel data.

2. The method of claim 1, wherein the memory is a non-volatile memory.

3. The method of claim 1, wherein the tuning device is a set-top box.

4. The method of claim 1, wherein the event is at least one of an interruption of power to the tuning device, and a failure of the tuning device.

5. The method of claim 1, wherein channel data is stored in the memory each time the tuning device is tuned to a different channel.

6. The method of claim 3, wherein each time channel data is stored in the memory, previous channel data stored in the memory is deleted.

7. A tuning device including:
a memory;
a channel storing module to access the memory and to write channel data to the memory, the channel data identifying a channel to which a tuning device is tuned; and
a recovery module which, after the occurrence of an event, accesses the channel data stored in the memory and tunes the tuning device to the channel identified by the channel data.

8. The device of claim 7, wherein the memory is a non-volatile memory.

9. The device of claim 7, wherein the tuning device is a set-top box.

10. The device of claim 7, wherein the event is at least one of an interruption of power to the tuning device, and a failure of the tuning device.

11. The device of claim 7, wherein the channel storing module is to store channel data in the memory each time the tuning device is tuned to a different channel.

12. The device of claim 7, wherein the channel storing module is to delete previous channel data stored in the memory each time channel data is stored in the memory.

13. A tuning device including:
a memory;
channel storing means to access the memory and to write channel data to the memory, the channel data identifying a channel to which a tuning device is tuned; and
recovery means which, after the occurrence of an event, accesses the channel data stored in the memory and tunes the tuning device to the channel identified by the channel data.

14. The device of claim 13, wherein the memory is a non-volatile memory.

15. The device of claim 13, wherein the tuning device is a set-top box.

16. The device of claim 13, wherein the event is at least one of an interruption of power to the tuning device, and a failure of the tuning device.

17. The device of claim 13, wherein the channel storing means stores channel data in the memory each time the tuning device is tuned to a different channel.

18. The device of claim 7, wherein the channel storing means deletes previous channel data stored in the memory each time channel data is stored in the memory.

19. A machine-readable medium having instructions that, when executed by a machine, cause the machine to perform a method including:
storing, in a memory of a tuning device, channel data identifying a channel to which the tuning device is tuned; and
after the occurrence of an event, accessing the memory to retrieve the channel data and tuning the tuning device to the channel identified by the channel data.
